(19) United States
(12) Patent Application Publication
(10) Pub. No.: US 2014/0098100 A1
(43) Pub. Date: Apr. 10, 2014

(54) MULTIVIEW SYNTHESIS AND PROCESSING SYSTEMS AND METHODS

(71) Applicant: Qualcomm Incorporated, San Diego, CA (US)

(72) Inventors: Gokce Dane, San Diego, CA (US); Vasudev Bhaskaran, San Diego, CA (US)

(73) Assignee: Qualcomm Incorporated, San Diego, CA (US)

(21) Appl. No.: 14/046,858

(22) Filed: Oct. 4, 2013

Related U.S. Application Data
(60) Provisional application No. 61/710,528, filed on Oct. 5, 2012.

(51) Int. Cl. G06T 15/20; H04N 13/04; H04N 13/00

(52) U.S. Cl. CPC G06T 15/20; H04N 13/0011; H04N 13/0402
USPC 345/427

(57) ABSTRACT

Certain embodiments relate to systems and methods for presenting an autostereoscopic, 3-dimensional image to a user. The system may comprise a view rendering module to generate multi-view autostereoscopic images from a limited number of reference views, enabling users to view the content from different angles without the need of glasses. Some embodiments may employ two or more reference views to generate virtual reference views and provide high quality stereoscopic images. Certain embodiments may use a combination of disparity-based depth map processing, view interpolation and smart blending of virtual views, artifact reduction, depth cluster guided hole filling, and post-processing of synthesized views.

### CROSS-REFERENCE TO RELATED APPLICATIONS

The present application claims the benefit under 35 U.S.C. §119(e) of U.S. Provisional Patent Application No. 61/710,528, filed on Oct. 5, 2012, entitled “MULTIVIEW SYNTHESIS AND PROCESSING METHOD,” the entire contents of which is hereby incorporated by reference herein in its entirety and for all purposes.

### TECHNICAL FIELD

The systems and methods disclosed herein relate generally to image generation systems, and more particularly, to reference view generation for display of autostereoscopic images.

### BACKGROUND

Stereoscopic image display is a type of multimedia that allows the display of three-dimensional images to a user, normally by presenting separate left and right eye images to a user. The corresponding displacement of objects in each of the images provides the user with an illusion of depth, and thus a stereoscopic effect. Once an electronic system has acquired the separate left and right images that make up a stereoscopic image, various technologies exist for presenting the left/right eye image pair to a user, such as shutter glasses, polarized lenses, autostereoscopic screens, etc. With regard to the autostereoscopic screens, it is preferable to display not only two parallax images for each the left eye and right eye, but also more parallax images.

The 3-dimensional display technology referred to as autostereoscopic allows a viewer to see the 3-dimensional content displayed on the autostereoscopic screen stereoscopically without using special glasses. This autostereoscopic display apparatus displays a plurality of images with different viewpoints. Then, the output directions of light rays of those images are controlled by, for example, a parallax barrier, a lenticular lens or the like, and guided to both eyes of the viewer. When a viewer's position is appropriate, the viewer sees different parallax images respectively with the right and left eyes, thereby recognizing the content as 3-dimensional.

However, there has been a problem with autostereoscopic displays in that capturing multiple views from multiple cameras can be expensive, time consuming and impractical for certain applications.

### SUMMARY

Implementations described herein relate to generating virtual reference views at virtual sensor locations by using actual reference view or views and depth map data. The depth or disparity maps associated with actual reference views are subjected to disparity or depth based processing in some embodiments, and the disparity maps can be segmented into foreground and background pixel clusters to generate depth map data. Scaling disparity estimates for the reference views can be used in some embodiments to map the pixels from the reference views to pixel locations in an initial virtual view at a virtual sensor location. Depth information associated with the foreground and background pixel clusters can be used to merge the pixels mapped to the initial virtual view into a synthesized view in some embodiments. Holes in the virtual view can be filled using inpainting considering the depth level of a hole location and a corresponding depth level of a pixel or pixel cluster in a reference view. Some embodiments may apply artifact reduction and further processing to generate high quality virtual reference views to use in presenting autostereoscopic images to users.

One aspect relates to a method comprising receiving image data comprising at least one reference view, the at least one reference view comprising a plurality of pixels; conducting depth processing on the image data to generate depth values for the plurality of pixels; generating an initial virtual view by mapping the pixels from the at least one reference view to a virtual sensor location, wherein generating the initial virtual view further comprises tracking the depth values associated with the mapped pixels; refining the initial virtual view via artifact detection and correction into a refined view; conducting 3D hole filling on identified hole areas in the refined view to generate a hole-filled view; and applying post-processing to the hole-filled view.

Another aspect relates to a system for rendering a stereoscopic effect for a user, the system comprising: a depth module configured to receive image data comprising at least one reference view, the at least one reference view comprising a plurality of pixels, and to conduct depth processing on the image data to generate depth values for the plurality of pixels; a view generator configured to generate an initial virtual view by mapping the pixels from the at least one reference view to a virtual sensor location, and track the depth values associated with the mapped pixels; a view refinement module configured to refine the initial virtual view via artifact detection and correction into a refined view; and a hole filler configured to perform 3D hole filling on identified hole areas in the refined view to generate a hole-filled view.

### BRIEF DESCRIPTION OF THE DRAWINGS

Specific implementations of the invention will now be described with reference to the following drawings, which are provided by way of example, and not limitation.

FIG. 1A illustrates an embodiment of an image capture system for generating autostereoscopic images;

FIG. 1B illustrates a block diagram of an embodiment of a reference view generation system incorporating the image capture system of FIG. 1A;

FIG. 2 illustrates an embodiment of a reference view generation process;

FIG. 3 illustrates an embodiment of a depth processing process that can be implemented in the reference view generation process of FIG. 2;

FIG. 4 illustrates an embodiment of a view rendering process that can be implemented in the reference view generation process of FIG. 2; and

FIG. 5 illustrates an embodiment of a depth-guided inpainting process that can be implemented in the reference view generation process of FIG. 2.

### DETAILED DESCRIPTION

### Introduction

Implementations disclosed herein provide systems, methods and apparatus for generating reference views for production of a stereoscopic image with an electronic device having one or more imaging sensors and with a view processing module. One skilled in the art will recognize that these embodiments may be implemented in hardware, software, firmware, or any combination thereof.

In the following description, specific details are given to provide a thorough understanding of the examples. However, it will be understood by one of ordinary skill in the art that the examples may be practiced without these specific details. For example, electrical components/devices may be shown in block diagrams in order not to obscure the examples in unnecessary detail. In other instances, such components, other structures and techniques may be shown in detail to further explain the examples.

It is also noted that the examples may be described as a process, which is depicted as a flowchart, a flow diagram, a finite state diagram, a structure diagram, or a block diagram. Although a flowchart may describe the operations as a sequential process, many of the operations can be performed in parallel, or concurrently, and the process can be repeated. In addition, the order of the operations may be re-arranged. A process is terminated when its operations are completed. A process may correspond to a method, a function, a procedure, a subroutine, a subprogram, etc. When a process corresponds to a software function, its termination corresponds to a return of the function to the calling function or the main function.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Embodiments of the invention relate to systems and methods for synthesizing different autostereoscopic views from captured or computer-synthesized images. In one embodiment, the system uses one or more reference views taken from a digital camera of an image scene. The system then uses associated depth maps to synthesize other views, from other camera angles, of the image scene. For example, eight different views of a scene may be synthesized from the capture of a single stereoscopic image of the scene.

A synthesized view is rendered as if captured by a virtual camera located somewhere near the real image sensors which captured the reference stereoscopic image. The synthesized view is generated from information extracted from the reference stereoscopic image, and may have a field of view that is not identical, but is very similar to that of the real camera.

In one embodiment, a view synthesis process begins when the system receives one or more reference views from a stereoscopic image capture device, along with corresponding depth map information of the scene. Although the system may receive depth maps associated with some or all of the reference views, in some instances unreliable disparity or depth map information may be provided due to limitations of the image capture system or the disparity estimator. Therefore, the view synthesis system can performs depth processing, as described in more detail below, to improve flawed depth maps or to generate depth maps for reference views that were not provided with associated depth maps. For example, a certain pixel of the captured image may not have corresponding depth information. In one embodiment, histogram data of surrounding pixels may be used to extrapolate depth information for the pixel and complete the depth map. In another example, a k-means clustering technique may be used for depth processing. As is known, a k-means clustering technique relates to a method of vector quantization which aims to partition n observations into k clusters so that each observation belongs to the cluster with the nearest mean, serving as a prototype of the cluster. This results in a partitioning of the data space into Voronoi cells. This is discussed in more detail below.

From the completed depth maps, an initial view is generated by mapping the pixels from a reference view to a virtual view (at a determined camera location) by appropriately scaling disparity vectors in one embodiment. Associated depth values for each pixel may be tracked. Information contained in the luminance intensity depth maps may be used to shift pixels in a reference view to generate a new image as if it were captured from a different viewpoint. Next, the reference view and virtual view are merged into a synthesized view by considering depth values. In some embodiments, the system can perform a process of “intelligent selection” wherein depth values are close to each other. The synthesized view is refined by an artifact detection and correction module which is configured to detect artifacts in the merged views and correct for any errors derived from the merging process.

In addition, embodiments may perform a hole filling operation on the synthesized view. For example, depth maps and pixel values of pixel areas near to, or surrounding, the hole may be analyzed so that hole filling is conducted in the 3D domain, for example by filling from background data where it is determined that the hole is in the background.

Post-processing may be applied for final refinement of the synthesized view. For instance, post-processing may involve determining which pixels in the synthesized view are from a right view and which are from a left view. Additional refinement may be applied where there is a boundary of pixels from the left view and right view. After post-processing, the synthesized view, from the new viewpoint, is ready for display on an autostereoscopic screen.

### System Overview

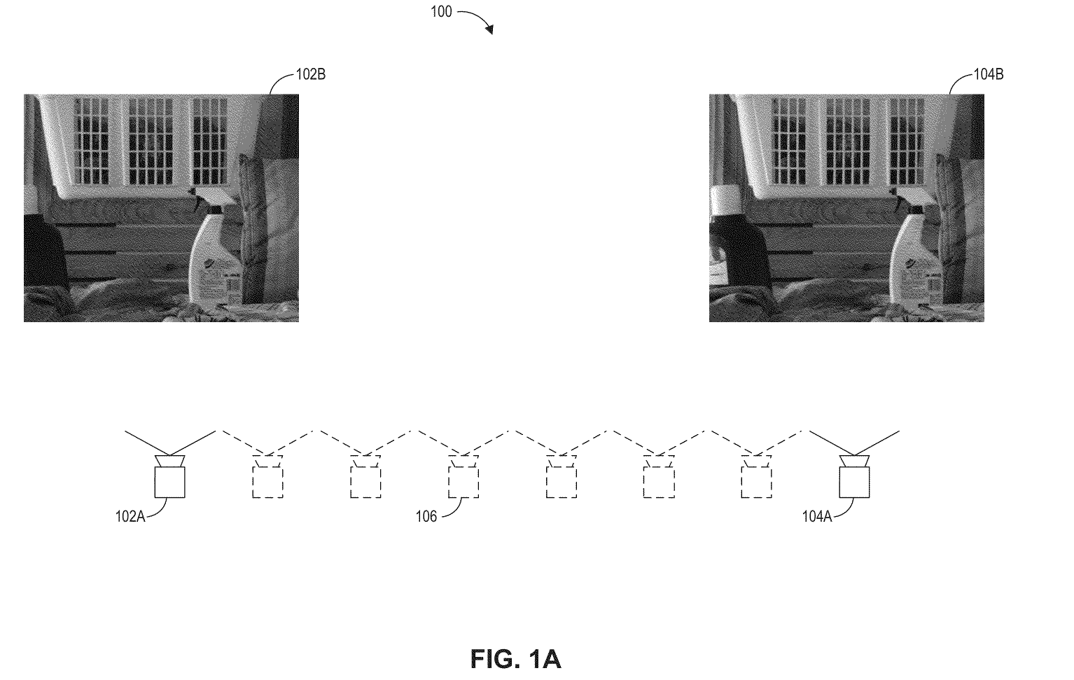

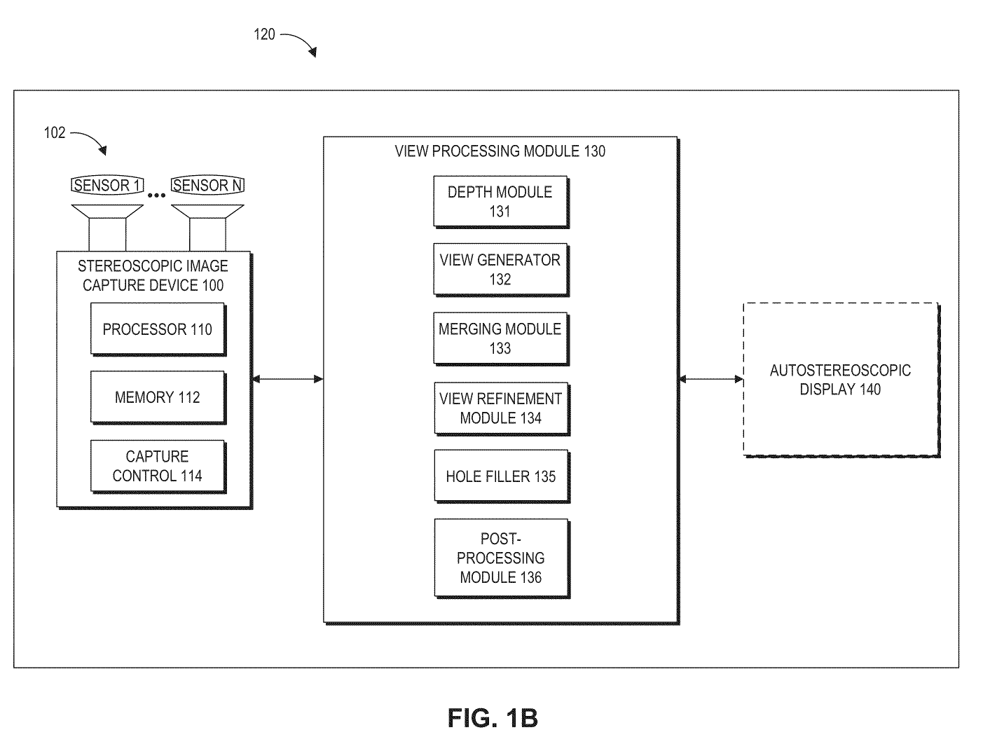

FIG. 1A illustrates an example image capture device 100 that can be used to capture reference views for generating autostereoscopic images. As illustrated, the system includes a left image sensor 102A that captures an image of the target scene from a left view to use as a left reference view 102B and a right image sensor 104A that captures an image of the target scene from a right view to use as a right reference view 104B.

The system also includes a plurality of virtual sensor locations 106. The virtual sensor locations represent additional viewpoints at which a reference view is needed to generate an autostereoscopic image. Although the image capture device 100 is illustrated as having actual sensors at the left-most and right-most viewpoints and virtual sensor locations at six intermediate viewpoints, this is for illustrative purposes and is not intended to limit the image capture device 100. Other configurations of virtual sensor locations and actual sensors, as well as varying numbers of virtual sensor locations and actual sensors, are possible in other embodiments.

FIG. 1B illustrates a schematic block diagram of an embodiment of a reference view generation system 120 incorporating the image capture system 100 of FIG. 1A, though any image capture system can be used in other embodiments. In some embodiments, instead of an image capture device 100, a computer system may be used to synthesize views of computer-generated content. The image capture device 100 can be configured to capture still photographic images, video images, or both. As used herein, the term “image” can refer to either a still image or a sequence of still images in a movie.

The image capture device 100 includes a plurality of sensors 102. Any number N of sensors 102 can be incorporated into the image capture device 100, for example one, two, or more in various embodiments. In the illustrated implementation, the image capture device 100 may be a stereoscopic image capture device with multiple image sensors 102. In other implementations a single sensor image capture device can be used. In some implementations, a charge-coupled device (CCD) can be used as the image sensor(s) 102. In other implementations, a CMOS imaging sensor can be used as the image sensor(s) 102. The sensor(s) 102 can be configured to capture a pair or set of images simultaneously or in sequence.

The image capture device 100 further includes a processor 110 and a memory 112 that are in data communication with each other and with the image sensor(s) 102. The processor 110 and memory 112 can be used to process and store the images captured the image sensor(s) 102. In addition, the image capture device 100 can include a capture control module 114 configured to control operations of the image capture device 100. The capture control module 114 can include can include instructions that manage the capture, receipt, and storage of image data using the image sensor(s) 102.

Image data including one or more reference views at one or more viewpoints can be sent from the image capture device 100 to the view processing module 130. The view processing module 130 can use the image data to generate a number of reference views at virtual sensor locations, which may be viewpoints in between or near the viewpoints of the reference views captured by the image capture device. The view processing module can include a depth module 131, view generator 132, merging module 133, view refinement module 134, hole filler 135, and post-processing module 136. In embodiments configured to process only one reference view received from the image capture device 100, the merging module 133 can be optional.

The depth module 131 can generate depth information for the image data provided to the view processing module. In some embodiments, image data includes one or more reference views, each including a plurality of pixels, and associated depth value data for at least some of the pixels in the reference view(s). However, such provided depth value data is often inaccurate, incomplete, or in some embodiments is not provided. This can cause flickering artifacts in multi-view video playback and can cause “holes” or artifacts in multi-view images that may need to be filled with additional depth map data. Further, in some embodiments the image data includes one or more reference views without depth value data. The depth module 131 can generate or correct depth value information associated with the image data for more robust autostereoscopic image generation, as discussed in more detail below.

In some embodiments, the depth module 131 can fill holes in depth map data included in the image data. The depth module 131 can look at areas around a pixel without associated depth value information to determine a depth value for the pixel. For example, histogram data of surrounding pixels may be used to extrapolate depth information for the pixel.

In another example, a k-means clustering technique may be used for depth processing. For example, the image data may include a left reference view and a right reference view. The depth module 131 can generate a disparity map representing a distance between corresponding pixels in the left and right reference view, which include the same target image scene from different perspectives. In some embodiments, the depth module 131 can generate a left-to-right disparity map and a right-to-left disparity map for additional accuracy. The depth module 131 can then segment the disparity map into foreground and background objects, for example by a k-means technique using two clusters. The depth module 131 can calculate the centroid of the clusters and can use the centroids to calculate the mean disparity for the foreground object or objects. In implementations generating virtual reference views for video display, processing can be conserved in some embodiments by skipping frames where temporal change between frames is small. In some embodiments, more than two clusters can be used, for example for image scenes having complex depth levels for the objects in the scene. The two-cluster embodiment can be used for fast cost volume filtering based depth value generation.

The view generator 132 can use the depth value information from the depth module 131 to generate an initial virtual view at a virtual sensor location. For example, the initial virtual view can be generated by mapping the pixels in the reference view or views to the location of the virtual sensor. This can be accomplished, in some embodiments, by scaling the disparities between the corresponding pixels in left and right reference views to correspond to the virtual sensor location. In some embodiments, pixels of a single reference view may be mapped to the virtual sensor location. Depth values associated with the mapped pixels can be tracked.

The merging module 133 can be used, in some embodiments with image data having at least two reference views, to merge the reference views into a synthesized view based on the mapped pixels in the initial virtual view. The merging module 133 can use the depth values associated with the mapped pixels in the initial virtual view to determine whether a mapped pixel from one of the reference views is foreground or background of the image scene, and may blend or merge corresponding pixels from the reference views according to the foreground and background. When depth values for corresponding pixels from the reference views are similar, other attributes of the pixels and/or depth values and attributes of surrounding pixels may be can be used to determine which pixel to use in the foreground and which pixel to use in the background. In some embodiments, the luminance and chrominance values of pixels having similar depth values and mapped to the same pixel location in the initial virtual view may be averaged for output as an initial virtual view pixel. In implementations in which the image data includes only one reference view, the merging module 133 may not be used in generating virtual reference views.

The view refinement module 134 can perform artifact detection and correction on the initial virtual view from the view generator 132 or the synthesized view from the merging module 133. Artifacts can be caused by an over-sharp look and aliasing effects due to improper merging of the views, or if an object is placed in the wrong depth level due to inaccurate blending.

The hole filler 135 can perform three-dimensional hole filling techniques on the refined view generated by the view refinement module 134. Individual pixels or pixel clusters can be identified as hole areas for hole filling during generation of the initial virtual view by the view generator 132. For example, a hole area can be an area in the initial virtual view where no input pixel data is available for the area. Such unassigned pixel values cause artifacts called ‘holes’ in a resulting multi-view autostereoscopic image.

For example, hole areas can be identified by areas where depth values of adjacent pixels or pixel clusters in the reference view(s) and/or initial virtual view change a lot, such as by having a difference above a predetermined threshold. Hole areas can be identified in some implementations if it is determined that a foreground object is blocking the background, in the reference view(s), and the pixel or pixel cluster in the initial virtual view is assigned to the background. In some implementations, hole areas can be identified where no pixel data from the reference view or views may be mapped to the pixel or pixel cluster.

In some embodiments, the hole filler 135 can prioritize the hole areas and identify the area with the highest priority. Priority can be based on a variety of factors such as the size of the area to be filled, the assignment of foreground or background to the area, depth values of pixels around the area, proximity of the area to the center of the image scene, proximity to human faces detected through facial recognition techniques, or the like. The hole filler 135 may begin by generating pixel data for a highest priority area to be filled, and may update the priorities of the remaining areas. A next highest area can be filled next and the priorities updated again until all areas have been filled.

In order to generate pixel data for hole areas, in some embodiments the hole filler 135 can search in the left and right reference views within a search range for pixel data to copy into the hole area. The search range and center of a search location can be calculated by a disparity between corresponding pixels in the left and right reference views within the hole area, at the edge of a hole area, or in areas adjacent to the hole area. The pixel or patch that minimizes the sum squared error can be selected to copy into at least part of the hole. In some embodiments, the hole filler 135 can search for multiple pixels or patches from the left and right reference views to fill a hole area.

The post-processing module 136 can be used to further refine the virtual view output by the hole filler 135. For example, the post-processing module 136 can, in some embodiments, apply a Gaussian filter to part or all of the virtual view. Such post-processing can be selectively applied in some embodiments for example to areas having large depth value differences between adjacent pixels or where there is a boundary of pixels that originated in the left and right reference views.

The view processing module 130 and its component modules can be used to generate one virtual reference view or more depending on the needs of an autostereoscopic display 140. The autostereoscopic display 140 can optionally be included in the view generation system 120 in some embodiments, however in other embodiments the view generation system 120 may not include the display 140 and may store the views for later transmission to or presentation on a display. Though not illustrated, a view mixing module can be used to generate a mixing pattern for the captured and generated reference views for autostereoscopic presentation on the display.

### Process Overview

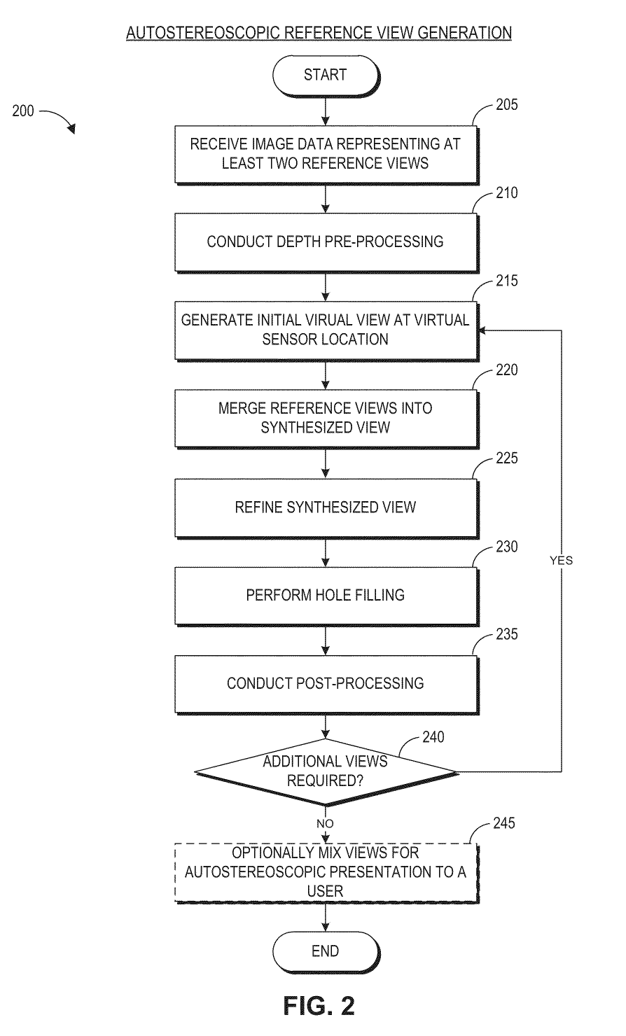

FIG. 2 illustrates one possible process 200 for generating virtual reference views in order to generate a three-dimensional image for autostereoscopic display.

At block 205, an autostereoscopic image generation system receives data representing a reference view or a plurality of reference views. The data may also include a depth map associated with each reference view. The autostereoscopic image generation system can be the view processing module 130 of FIG. 1B or any suitable system. To produce a stereoscopic image generally requires that the reference views contain at least a left eye view and a right eye view. In some embodiments, the system receives only one reference view from an image sensor. Newly generated views will be rendered as if they were captured by a virtual camera located somewhere near the real camera through information extracted from the original image from the real camera, and the newly generated view may have a field of view that is not identical but very similar to that of the real camera. Thus, method 200 will employ a plurality of 2D material to create stereoscopic 3D.

Although the process 200 may receive depth maps associated with some or all of the reference views, at block 210 the process 200 performs depth processing, for example at the depth module 131 of FIG. 1B. In some instances, unreliable disparity or depth map information may be provided to the system due to limitations of the 3D capture system or the disparity estimator. Stereo matching may not work well for estimating depth in less-textured, repeated textured regions, or disocclusion regions, producing imperfect depth/disparity maps. View synthesis conducted with such depth/disparity maps could lead into visual artifacts in synthesized frames. Therefore, at block 210 the process 200 performs depth processing to improve flawed depth maps or to generate depth maps for reference views that were not provided with associated depth maps.

At block 215, an initial view is generated by mapping the pixels from a reference view to a virtual view (at a determined camera location) by appropriately scaling the disparities. For example, a virtual view located half way between a left reference view and a right reference view would correspond to a scaled disparity value of 0.5. Associated depth values for each pixel are tracked as the pixels are mapped to virtual view locations. Information contained in the luminance intensity depth maps may be used to shift pixels in a reference view to generate a new image as if it were captured from a new viewpoint. The larger the shift (binocular parallax), the larger is the perceived depth of the generated stereoscopic pair. Block 215 can be accomplished by the view generator 132 of FIG. 1B in some implementations.

At block 220, which can be carried out by the merging module 133 of FIG. 1B in some embodiments, the reference views are merged into a synthesized view by considering depth values. The process 200 can be equipped with a process for intelligent selection when depth values are close to each other, for example by averaging pixel values in some embodiments or using adjacent depth values to select a pixel from a left or right reference view for the synthesized view. Blending from two different views can lead to an over-sharp look and aliasing-like artifacts in synthesized frames if not done properly. Inaccurate blending can also bring objects that were at the back of the scene to the front of the scene and vice versa. In embodiments of the process 200 in which the initial image data only included one reference view, the view merging of block 220 may be skipped and the process 200 can move from block 215 to block 225.

The process 200 at block 225 refines the synthesized view. This can be conducted by an artifact detection and correction module, such as the view refinement module 134 of FIG. 1B, which is configured to detect artifacts in the merged views and correct for any errors derived from the merging process. In some embodiments, an artifact map can be produced using a view map generated from the mapped pixels in the synthesized view. The view map may categorize pixel locations as being pixels from the left reference view image, right reference view image, or a hole where no pixel data is associated with the pixel location. The artifact map can be generated, for example, by applying edge detection with a Sobel operator on the view map, applying image dilation, and for each pixel identified as an artifact, applying a median for a neighborhood of adjacent pixels. The artifact map can be used for correction of pixel data at locations having missing or unreliable disparity estimates along depth discontinuities in some implementations. These artifacts may be corrected through hole-filling, as discussed below.

At block 230, hole-filling is performed on the synthesized view, for example by the hole-filler 135 of FIG. 1B. A known problem with depth-based image rendering is that pixels shifted from a reference view or views now occupy new positions and leave areas that they originally occupied empty, known as disoccluded. These disoccluded regions have to be filled properly, known as hole-filling, otherwise they can degrade the quality of the final autostereoscopic image. Hole-filling may be required as some areas in the synthesized view may not have been present in either reference view and this creates holes in the synthesized view. Robust techniques are needed to fill those hole areas.

At block 235, post-processing is applied for final refinement of a hole-filled virtual view, for example by applying a Gaussian blur to pixel boundaries in the virtual view between pixels obtained from the right and left reference views, or pixel boundaries between foreground and background depth clusters, or adjacent pixels having a large difference in depth values. This post-processing can be accomplished by the post-processing module 136 of FIG. 1B, in some embodiments. Thereafter, the synthesized view is ready for use in displaying a multi-view image on an autostereoscopic screen.

The process 200 then moves to block 240 where it is determined whether additional virtual reference views are needed for the multi-view autostereoscopic image. For example, in certain implementations of autostereoscopic display, eight total views may be needed. If additional views are needed, the process 200 loops back to block 215 to generate an initial virtual view at a different virtual sensor location. The required number of views can be generated at evenly sampled virtual sensor viewpoint locations between left and right actual sensor locations in some embodiments. If no additional views are needed, then the process 200 optionally mixes the views for autostereoscopic presentation of the final multi-view image. However, in some embodiments the process 200 ends by outputting unmixed image data including the reference views and virtual reference views to a separate mixing module or a display equipped to mix the views. Some embodiments may output the captured and generated views for non-stereoscopic display, for example to create a video or set of images providing a plurality of viewpoints around an object or scene. The views may be output with sensor or virtual sensor location data.

Although various views are discussed in the process 200 of FIG. 2, such as an initial virtual view, a synthesized view, a refined view, and a hole-filled view, such terminology is meant to illustrate the operative effects of various stages of the process 200 on the virtual view being generated. The various steps of the process 200 can be understood more generally to operate on a virtual view or a version of the virtual view. In some embodiments, certain steps of the process 200 could be omitted, and in some implementations the steps may be performed in a different order than discussed above. The illustrated and discussed order is meant to provide one example of a flow of the process 200 and not to limit the process 200 to a particular order or number of stages.

### Depth Processing Overview

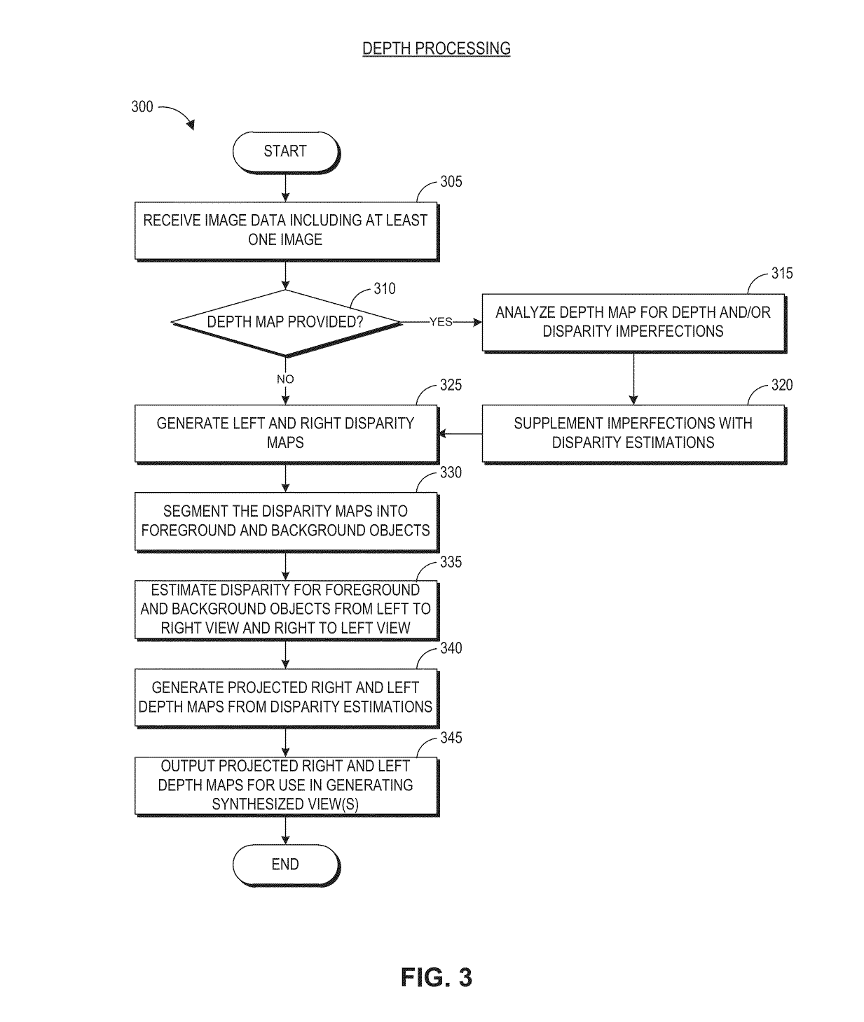

FIG. 3 illustrates an example of a depth processing process 300 that can be used at block 210 of the reference view generation process 200 of FIG. 2, described above. The process 300 in other embodiments can be used for any depth map generation needs, for example in image processing applications such as selectively defocusing or blurring an image or subsurface scattering. For ease of illustration, the process 300 is discussed in the context of the depth module 131 of FIG. 1B, however other depth map generation systems can be used in other embodiments.

The process 300 begins at step 305 in which the depth module 131 receives image data representing a reference view or a plurality of reference views. In some embodiments, the image data may also include a depth map associated with each reference view. In some embodiments, the depth module 131 may receive only one reference view and corresponding depth information from an image sensor. In other embodiments, the depth module 131 may receive a left reference view and a right reference view without any associated depth information.

Accordingly, at block 310 the depth module 131 determines whether depth map data was provided in the image data. If depth map data was provided, then the process 300 transitions to block 315 in which the depth module 131 analyzes the depth map for depth and/or disparity imperfections. The identified imperfections are logged for supplementation with disparity estimations. In some embodiments, the provided depth map data can be retained for future use in view merging, refining, hole filling, or post-processing. In other embodiments, the provided depth map data can be replaced by the projected depth map data generated in process 300.

If no depth map data is provided, or after identifying imperfections in provided depth map data, the process 300 moves to block 325 in which the depth module 131 generates at least one disparity map. In some embodiments, the depth module 131 can generate a left-to-right disparity map and a right-to-left disparity map to improve reliability.

At block 330, the depth module 131 segments the disparity map or maps into foreground and background objects. In some embodiments, the depth module 131 may assume that two segments (foreground and background) are present in the overall disparity data per image and can solve for the centroids via k-means cluster algorithm using two clusters. In other embodiments, more clusters can be used. For example, let (x₁, x₂, . . . , x_{S}) be positive disparity values (disparity values can be shifted by offset to assure +ve) and let S=W×H (Width×Height). Solve for μᵢ for k=2 via Equation (1):

$${arg min}_{S} {\sum }_{i = 1}^{k} {\sum }_{{x}_{j} ∈ {S}_{i}}^{ } {‖ {x}_{j} - {μ}_{i} ‖}^{2} \qquad ( 1 )$$

At block 335, the depth module 131 estimates disparity values for foreground and background objects (where objects can be identified at least partly by foreground or background pixel clusters). To improve reliability, some embodiments can find centroid values of foreground and background clusters to estimate for disparities from left to right reference view as well as from right to left reference view according to the set of Equations (2) and (3):

(X_{LR1}, X_{LR2}, . . . , X_{LRS})→μ_{LR}_{_{—}}_{FG &} μ_{LR}_{_{—}}_{BG} (2)

(X_{RL1}, X_{RL2}, . . . , X_{RLS})→μ_{RL}_{_{—}}_{FG &} μ_{RL}_{_{—}}_{G} (3)

For further reliability, in some embodiments the depth module 131 can incorporate temporal information and use μ_{LR}_{_{—}}_{FG(t-1)}, μ_{RL}_{_{—}}_{FG(t-1)}, μ_{LR}_{_{—}}_{FG(t)}, μ_{RL}_{_{—}}_{FG(t)} for foreground disparity estimations.

Accordingly, at block 340, the depth module 131 can generate projected left and right depth maps from the disparity estimations. If the depth module 131 determines that a disparity corresponds to an unreliable background, the depth value for a pixel or pixels associated with the disparity can be identified as a hole area for future use in a hole filling process. The projected right and left depth maps can be output at block 345, together with information regarding hole area locations and boundaries in some implementations, for use in generating synthesized views.

### View Rendering Overview

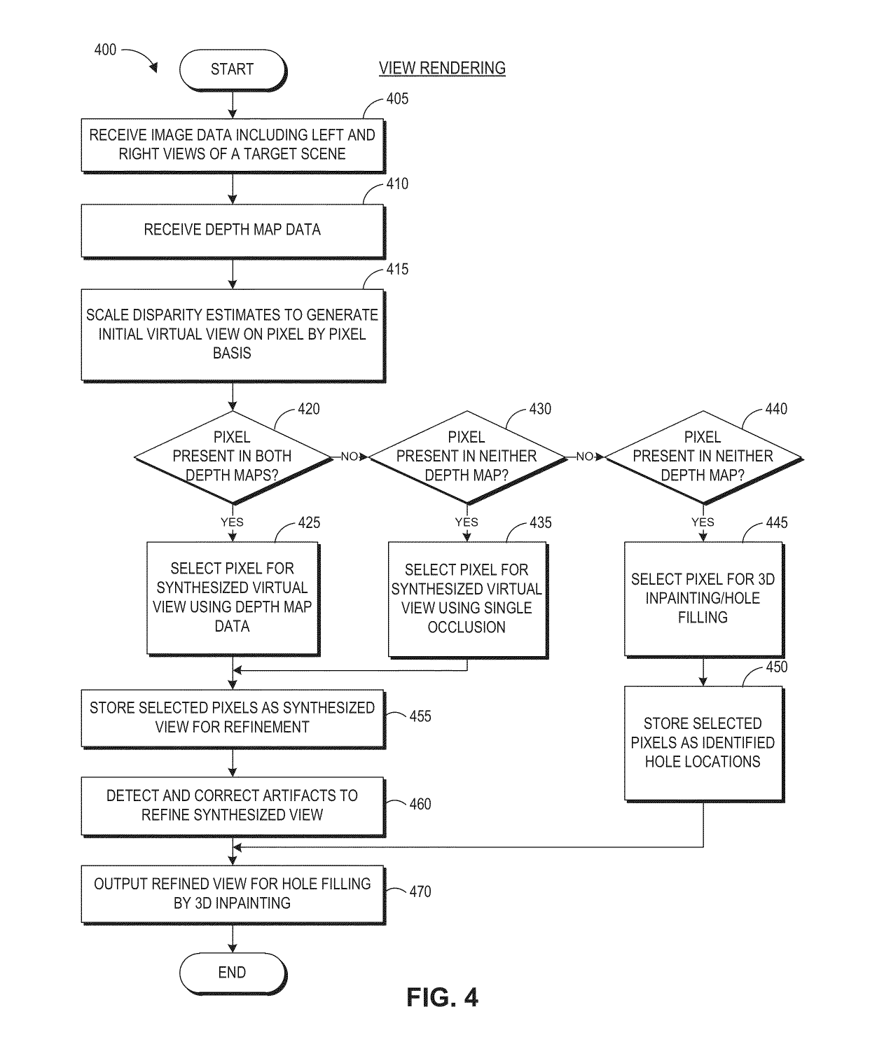

FIG. 4 illustrates an example of a view rendering process 400 that can be used at blocks 215 and 220 of the reference view generation process 200 of FIG. 2, described above. The process 400 in other embodiments can be used for any virtual view generation applications. For ease of illustration, the process 400 is discussed in the context of the view generator 132 and merging module 133 of FIG. 1B, however other view rendering systems can be used in other embodiments.

The view rendering process 400 begins at block 405 when the view generator 132 receives image data including left and right reference views of a target scene. At block 410, the view generator 132 receives depth map data associated with the left and right reference views, for example projected left and right depth map data such as is generated in the depth processing process 300 of FIG. 3, described above.

At block 415, the view generator scales disparity estimates included in the depth data to generate an initial virtual view. The initial virtual view may have pixels from both, one, or neither of the left and right reference views mapped to a virtual pixel location. The mapped pixels can be merged using depth data to generate a synthesized view. In some embodiments, assuming that the images are rectified, the pixels may be mapped from the two reference views into the initial virtual view by horizontally shifting the pixel locations by the scaled disparity of the pixels according to the set of Equations (4) and (5):

T_{L}(i, j−αD_{L}(i,j))=I_{L}(i,j) (4)

T_{R}(i, W−j+(1−α)D_{R}(i, W−j))=I_{R}(i, W−j) (5)

where I_{L} & I_{R} are left and right views; D_{L} & D_{R} are disparities estimated from left to right and right to left views; T_{L} & T_{R} are initial pixel candidates in the initial virtual view; 0<α<1 is the initial virtual view location; i & j are pixel coordinates, and W is the width of the image.

Accordingly, at block 420, the merging module 133 determines for a virtual pixel location whether the associated pixel data originated from both the left and right depth maps. If the associated pixel data was in both depth maps, then the merging module 133 at block 425 selects a pixel for the synthesized view using depth map data. In addition, there may be instances when multiple disparities map to a pixel coordinate in the initial reference view. The merging module 133 may select a pixel closest to the foreground disparity as the synthesized view pixel in some implementations.

If, at block 420, the merging module 133 determines that the associated pixel data for a virtual pixel location was not present in both depth maps, the process 400 transitions to block 430 in which the merging module 133 determines whether the associated pixel data was present in one of the depth maps. If the associated pixel data was in one of depth maps, then the merging module 133 at block 435 selects a pixel for the synthesized view using single occlusion.

If, at block 430, the merging module 133 determines that the associated pixel data for a virtual pixel location was not present in one of the depth maps, the process 400 transitions to block 440 in which the merging module 133 determines that the associated pixel data was not present in either of the depth maps. For instance, no pixel data may be associated with that particular virtual pixel location. Accordingly, the merging module 133 at block 445 selects the pixel location for three-dimensional hole filling. At block 450, the selected pixel is stored as an identified hole location.

Blocks 420 through 450 can be repeated for each pixel location in the initial virtual view until a merged synthesized view with identified hole areas is generated. The pixels selected at blocks 425 and 435 are stored at block 455 as the synthesized view.

At block 460, the process 400 detects and corrects artifacts to refine the synthesized view, for example at the view refinement module 134 of FIG. 1B. In some embodiments, an artifact map can be produced using a view map generated from the mapped pixels in the synthesized view. The view map may categorize pixel locations as being pixels from the left reference view image, right reference view image, or a hole where no pixel data is associated with the pixel location. In some embodiments, the artifact map can be generated, for example, by applying edge detection with a Sobel operator on the view map, applying image dilation, and for each pixel identified as an artifact, applying a median for a neighborhood of adjacent pixels. The artifact map can be used for correction of pixel data at locations having missing or unreliable disparity estimates along depth discontinuities in some implementations.

At block 465, the hole locations identified at block 450 and any uncorrected artifacts identified at block 460 are output for hole filling using three-dimensional inpainting, which is a process for reconstructing lost of deteriorated parts of a captured image, as discussed in more detail below.

### Hole Filling Overview

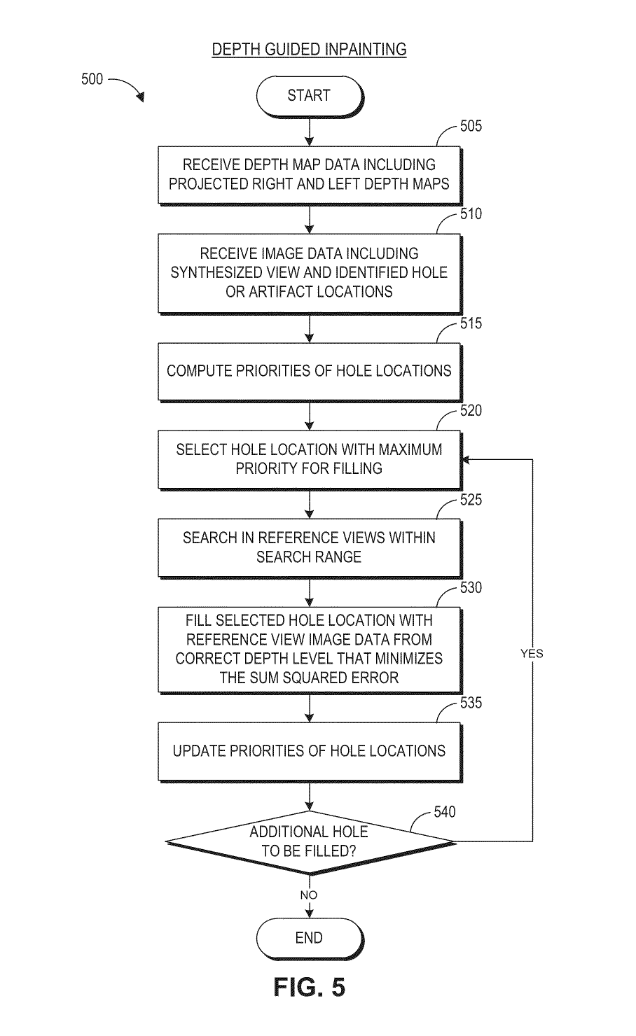

FIG. 5 illustrates an example of a hole filling process 500 that can be used at block 230 of the reference view generation process 200 of FIG. 2, described above. The process 500 in other embodiments can be used for any hole filling imaging applications. For ease of illustration, the process 500 is discussed in the context of the hole filler 135 of FIG. 1B, however other hole filling systems can be used in other embodiments.

The process 500 begins when the hole filler 135 receives, at block 505, depth map data, which in some implementations can include the left and right projected depth maps generated in the depth processing process 300 of FIG. 3, discussed above. At block 510, the hole filler 135 receives image data including pixel values of a synthesized view and identified hole or artifact locations in the synthesized view. As discussed above, individual pixels or pixel clusters can be identified as hole areas for hole filling during generation of the initial virtual view by the view generator 132. For example, a hole area can be an area in the initial virtual view where no input pixel data is available for the area, areas where depth values of adjacent pixels or pixel clusters in the reference view(s) and/or initial virtual view change a lot, where a foreground object is blocking the background, or where an artifact was detected by the view refinement module 134.

At block 515, the hole filler 135 can prioritize the hole areas. Priority can be calculated, in some embodiments, by a confidence in the data surrounding a hole area multiplied by the amount of data surrounding the hole area. In other embodiments, priority can be based on a variety of factors such as the size of the area to be filled, the assignment of foreground or background to the area, depth values of pixels around the area, proximity of the area to the center of the image scene, proximity to human faces detected through facial recognition techniques, or the like.

At block 520, the hole filler 135 can identify the hole area with the highest priority and select that hole area for three-dimensional inpainting. The hole filler 135 may begin by generating pixel data for a highest priority area to be filled, and may update the priorities of the remaining areas. A next highest area can be filled next and the priorities updated again until all areas have been filled.

In order to generate pixel data for hole areas, at block 525 the hole filler 135 can search in the left and right reference views within a search range for pixel data to copy into the hole area. The search range and center of a search location can be calculated by a disparity between corresponding pixels in the left and right reference views within the hole area, at the edge of a hole area, or in areas adjacent to the hole area. In some implementations, if a virtual pixel location within a hole is associated with foreground depth cluster data, then the hole filler 135 can search in foreground pixel data within the search range, and if the virtual pixel location within the hole is associated with background depth cluster data, then the hole filler 135 can be search in background pixel data within the search range.

At block 530, the hole filler 135 identifies he pixel or patch that minimizes the sum squared error, which can be selected to copy into at least part of the hole. In some embodiments, the hole filler 135 can search for multiple pixels or patches from the left and right reference views to fill a hole area.

At block 535, the hole filler 135 updates the priorities of the remaining hole locations. Accordingly, at block 540, the hole filler 135 determines whether any remaining holes are left for three-dimensional inpainting. If there are additional holes, the process 500 loops back to block 520 to select the hole having the highest priority for three-dimensional inpainting. When there are no remaining hole areas, the process 500 ends.

### Terminology

Those having skill in the art will further appreciate that the various illustrative logical blocks, modules, circuits, and process steps described in connection with the implementations disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. One skilled in the art will recognize that a portion, or a part, may comprise something less than, or equal to, a whole. For example, a portion of a collection of pixels may refer to a sub-collection of those pixels.

The various illustrative logical blocks, modules, and circuits described in connection with the implementations disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or process described in connection with the implementations disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of non-transitory storage medium known in the art. An exemplary computer-readable storage medium is coupled to the processor such the processor can read information from, and write information to, the computer-readable storage medium. In the alternative, the storage medium may be integral to the processor. The processor and the storage medium may reside in an ASIC. The ASIC may reside in a user terminal, camera, or other device. In the alternative, the processor and the storage medium may reside as discrete components in a user terminal, camera, or other device.

Headings are included herein for reference and to aid in locating various sections. These headings are not intended to limit the scope of the concepts described with respect thereto. Such concepts may have applicability throughout the entire specification.

The previous description of the disclosed implementations is provided to enable any person skilled in the art to make or use the present invention. Various modifications to these implementations will be readily apparent to those skilled in the art, and the generic principles defined herein may be applied to other implementations without departing from the spirit or scope of the invention. Thus, the present invention is not intended to be limited to the implementations shown herein but is to be accorded the widest scope consistent with the principles and novel features disclosed herein.

What is claimed is:

1. A computer-implemented method for rendering a stereoscopic effect for a user, the method comprising:
receiving image data comprising at least one reference view comprising a plurality of pixels;
generating depth values for the plurality of pixels;
generating a virtual view by mapping the pixels from the at least one reference view to a virtual sensor location;
tracking the depth values associated with the mapped pixels;
performing artifact detection and correction to refine the virtual view;
identifying hole areas in the virtual view; and
performing 3D hole filling on identified hole areas in the virtual view.

2. The computer-implemented method of claim 1, wherein the image data comprises a left reference view and a right reference view, wherein the left reference view depicts an image scene from a left viewpoint and the right reference view depicts the image scene from a right viewpoint

3. The computer-implemented method of claim 2, further comprising merging the mapped pixels of the virtual view into a synthesized view based at least in part on the depth values.

4. The computer-implemented method of claim 3, wherein performing artifact detection and correction on the virtual view comprises refining the synthesized view generated from the initial virtual view.

5. The computer-implemented method of claim 2, wherein generating depth values further comprises generating at least one disparity map from corresponding pixel locations in the left reference view and the right reference view.

6. The computer-implemented method of claim 5, wherein generating depth values further comprises generating at least one projected depth map from the at least one disparity map.

7. The computer-implemented method of claim 5, wherein generating depth values further comprises segmenting the at least one disparity map into foreground and background pixel clusters.

8. The computer-implemented method of claim 7, wherein generating depth values further comprises estimating disparity values for the foreground and background pixel clusters.

9. The computer-implemented method of claim 1, further comprising identifying the hole areas during one or more of generating depth values, mapping the pixels for generation of the virtual view, and performing artifact detection.

10. The computer-implemented method of claim 1, wherein conducting 3D hole filling further comprises:
determining a depth level of a pixel in an identified hole area, wherein the depth level is associated with a foreground depth value or a background depth value; and
searching within a search range of pixels of the at least one reference view for pixel data to fill the identified hole area, wherein the pixels of the at least one reference view are also associated with the depth level.

11. A system for rendering a stereoscopic effect for a user, the system comprising:
a depth module configured to:
receive image data comprising at least one reference view comprising a plurality of pixels, and
generate depth values for the plurality of pixels;
a view generator configured to:
generate a virtual view by mapping the pixels from the at least one reference view to a virtual sensor location, and
track the depth values associated with the mapped pixels;
a view refinement module configured to perform artifact detection and correction to refine the virtual view; and
a hole filler configured to perform 3D hole filling on identified hole areas in the virtual view.

12. The system of claim 11, further comprising a post-processing module configured to identify pixel areas of the virtual view for final processing.

13. The system of claim 11, further comprising a merging module configured to merge the mapped pixels of the virtual view into a synthesized view based at least in part on the depth values.

14. The system of claim 12, wherein the merging module is further configured to determine whether at least one pixel associated with each of a plurality of mapped pixel locations originated from one or both of a left reference view and a right reference view.

15. The system of claim 11, wherein the hole filler is further configured to prioritize the identified hole areas.

16. The system of claim 15, wherein the hole filler is further configured to select a highest priority hole area and to perform 3D hole filling on the highest priority hole area.

17. The system of claim 11, wherein the hole filler is further configured to:
determine a depth level of a pixel in an identified hole area, wherein the depth level is associated with a foreground depth value or a background depth value; and
search within a search range of pixels of the at least one reference view for pixel data to fill the identified hole area, wherein the pixels of the at least one reference view are also associated with the depth level.

18. The system of claim 17, wherein a center and range of the search range are calculated base at least partly on a disparity estimate associated with the pixel in the identified hole area.

19. The system of claim 11, wherein the hole filler is further configured to select pixel data from the at least one reference view to fill an identified hole area, wherein the pixel data minimizes a sum squared error.

20. A system for rendering a stereoscopic effect for a user, the system comprising:
means for receiving image data comprising at least one reference view comprising a plurality of pixels;
means for generating depth values for the plurality of pixels;
means for generating a virtual view by mapping the pixels from the at least one reference view to a virtual sensor location; and
means for conducting 3D hole filling on identified hole areas in the virtual view.
